SEQUENCE LISTING (1 sequence)

SEQ ID NO: 1 - protein, 269 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

(19) United States
(12) Patent Application Publication
(10) Pub. No.: US 2026/0097368 A1
(43) Pub. Date: Apr. 9, 2026

(54) SYSTEM AND METHODS FOR MIMICKING MEMBRANE CLEANING-IN-PLACE CONDITIONS

(71) Applicant: ECOLAB USA INC., Saint Paul, MN (US)

(72) Inventors: Stephan Doerries, Düsseldorf (DE); Matthias Schmitz, Düsseldorf (DE); Ralf Krack, Hilden (DE)

(21) Appl. No.: 19/351,927

(22) Filed: Oct. 7, 2025

Related U.S. Application Data
(60) Provisional application No. 63/704,380, filed on Oct. 7, 2024.

(51) Int. Cl. B01D 65/02; B01D 65/10

(52) U.S. Cl. CPC B01D 65/02; B01D 65/10; B01D 2321/166; B01D 2321/168; B01D 2321/44

(57) ABSTRACT

Cleaning-in-place (CIP) systems utilize membrane filters for purifying liquid substances in many industries, including but not limited to, the dairy industry, breweries, pharmaceutical industry, and the food industry. These membrane filters undergo a rigorous cleaning process that despite cleaning can leave foulants on the membranes which hamper filter effectiveness. In addition to the cleaning, enzymes can be applied to the membranes to remove foulants and restore filtering effectiveness. However, introduction of enzymes into these CIP systems can be problematic if enzymes remain after cleaning. This disclosure provides a system and methods to mimic the membrane modules and verify that a correct inactivation procedure occurred. The systems and methods include a separate membrane sample so that no membrane modules need be removed to verify full enzyme inactivation.

### CROSS-REFERENCE

This application claims priority under 35 U.S.C. § 119 to provisional application Ser. No. 63/704,380, titled “LIPASE DEACTIVATION FOR MEMBRANES IN CLEANING-IN-PLACE SYSTEMS”, filed Oct. 7, 2024, which is incorporated by reference in its entirety.

### SEQUENCE LISTING XML

The instant application contains a sequence listing, which has been submitted in XML file format by electronic submission and is hereby incorporated by reference in its entirety. The XML file, created on Jan. 6, 2026, is named P12159USU1.xml and is 2,181 bytes in size.

### TECHNICAL FIELD

The present disclosure relates generally to the field of membrane cleaning for breweries, dairy industry, and others that use cleaning-in-place (CIP). In particular, to improve on current systems and methods directed to deactivating enzymes in order to reduce time spent on disassembling and cleaning of systems.

### BACKGROUND

Membrane filtration is a process used to separate components in a liquid feed stream based on pressure-driven filtration through a membrane. The membrane acts as a selective barrier, allowing smaller molecules to pass through as permeate while larger molecules are retained as retentate. Over time, the membrane becomes fouled as particles and other components accumulate on its surface and within its pores, which leads to a decline in filtration efficiency. This fouling can be categorized into types such as inorganic, organic, particulate, and biofouling, with biofouling being particularly challenging as microorganisms form a biofilm on the membrane surface. To maintain efficiency, membranes must be regularly cleaned, a process that is complex and requires careful management of chemical and physical parameters to avoid damage to the membrane material and to ensure proper removal of cleaning compositions including the deactivation of enzymes.

Cleaning-in-place (CIP) is a critical maintenance procedure that has been developed for membrane filtration systems to remove fouling and restore membrane performance without needing to take the system apart. Food processing industries regularly use CIP clean-up procedures and automation. CIP systems are generally found in industries which produce fluidized ingestible products for humans or animals such as the dairy industry, breweries, the pharmaceutical industry, and the food industry. CIP preparation systems often require high sanitization when used in the production of ingestible substances. Generally, CIP systems utilize caustic cleaning compositions and monitor the amounts of the compositions via conductivity.

CIP involves several steps, including flushing the system, introducing chemical cleaning agents, and rinsing with clean water. The cleaning process is sensitive to various factors, such as chemical composition, temperature, and mechanical action, which need to be carefully controlled. The choice of cleaning agents depends on the type of fouling and the membrane material, with options ranging from acids and alkalis, to enzymes and oxidizing agents. Incorrect cleaning methods can cause irreversible damage to the membranes, such as chemical degradation, mechanical stress, and loss of membrane integrity.

Part of the CIP process that has proven effective at removing fat foulants includes introducing enzymes to break apart these fats, including triglycerides, to remove the fouling from the membranes. However, the introduction of enzymes can be problematic for some filters as enzymes are surface active and can get stuck in membrane pores. When lipase gets stuck in the membrane pores, this can lead to problems with food quality and/or safety should production continue while enzymes remain active in the membranes.

CIP systems are generally regarded as large production plant systems having reservoirs, pipes, pumps and mixing vessels which are incredibly time consuming to clean. To avoid possible food safety risk from enzymes, certain of which can convert triglycerides into glycerin and free fatty acids which create an off-taste for consumable products, the following systems and methods were developed for the proper monitoring and inactivation of enzymes without disassembly of the CIP systems.

### BRIEF SUMMARY OF PREFERRED EMBODIMENTS

Disclosed herein are systems and methods of deactivating enzymes for membranes in CIP systems. These methods provide various advantages over existing membrane cleaning methodologies. For example, the methods provide a mechanism to retain enzyme activity during the enzyme cleaning steps and then to deactivate the enzymes to avoid degradation of the produced product due to still active enzymes in the production process, which can create an “off-taste” of products via creation of small chain fatty acids. Another advantage of the methods is that they are suitable for a variety of types of filtration membranes, including, microfiltration, ultrafiltration, nanofiltration, and reverse osmosis membranes and others. Other advantages and benefits of the disclosed methods are described herein.

It is a primary object, feature, and/or advantage of the present disclosure to improve on or overcome the deficiencies in the art.

It is further an objective to not only verify correct dosing of inactivator compositions within a CIP system, but also to verify the proper implementation of inactivation conditions for solutions and compositions introduced into the CIP system such as time, pH, and temperature.

A preferred embodiment comprises a system for deactivating enzymes, which includes a cleaning-in-place system that comprises a feed tank with an opening, the feed tank operatively connected to an at least one pipe, and an at least one filtration module positioned downstream the at least one pipe, the at least one filtration module containing a plurality of membrane filters therein. The system further comprises a container containing a membrane filter positioned within the container, wherein the membrane filter is comprised of a same membrane type as the plurality of membrane filters that are within the at least one filtration module; and an inactivator composition, wherein the feed tank is filled with the inactivator composition, wherein the acidic composition is capable of deactivating enzymes including any of lipase, protease, or amylase, wherein the inactivator composition reaches the plurality of membrane filters because the feed tank is operatively connected to the at least one pipe with the at least one filtration module positioned downstream the at least one pipe; wherein the membrane filter positioned within the container is submerged in the inactivator composition.

According to some additional aspects of the present disclosure, the container is positioned in the feed tank.

According to some additional aspects of the present disclosure, the container is permeable.

According to some additional aspects of the present disclosure, the container includes a closable opening for insertion and removal of the membrane filter.

According to some additional aspects of the present disclosure, the container is inert to the inactivator composition.

According to some additional aspects of the present disclosure, the container is positioned in-line with the at least one pipe, downstream from the feed tank and upstream from the filtration module.

According to some additional aspects of the present disclosure, the container includes a closable opening for insertion and removal of the membrane filter.

According to some additional aspects of the present disclosure, the container is placed in-line with the at least one pipe via a first valve on the at least one pipe positioned upstream of the container, and a second valve on the at least one pipe positioned downstream of the container to divert flow form the at least one pipe to the container and back to the at least one pipe.

According to some additional aspects of the present disclosure, the container includes an at least one permeable surface to allow fluids to travel therethrough without allowing the membrane filter to travel therethrough.

According to some other aspects of the present disclosure, a method for verifying correct dosing of inactivator composition within a cleaning-in-place system (CIP system), comprising: placing a membrane filter in a test vessel and placing the test vessel in a feed tank of the CIP system. Further, inserting an enzyme composition into the feed tank and circulating the enzyme composition throughout the CIP system. Furthermore, inserting an inactivator composition into the feed tank capable of deactivating enzymes within the enzyme composition previously inserted into the CIP system and circulating the inactivator composition throughout the CIP system. Moreover, removing the test vessel from the feed tank and removing the membrane filter from the test vessel. Additionally testing the membrane filter for enzyme activity, wherein the CIP system includes a plurality of membrane filters positioned downstream from the feed tank within the CIP system that interact with both the enzyme composition and the inactivator composition when the enzyme composition and the inactivator composition are circulated throughout the CIP system, wherein the plurality of membrane filters are not accessible through from the feed tank, wherein the membrane filter that is tested for enzyme activity is tested instead of the plurality of membrane filters positioned downstream from the feed tank.

According to some additional aspects of the present disclosure, the method further includes inserting a surfactant as a part of the enzyme composition, and further comprising testing the membrane filter for residual surfactant in addition to testing for enzyme activity.

According to some additional aspects of the present disclosure, the method further includes each of inserting an intermediate rinse into the feed tank, circulating the intermediate rinse throughout the CIP system, and draining the intermediate rinse, all after circulating the enzyme composition throughout the CIP system.

According to some additional aspects of the present disclosure, the method further includes inserting an additional membrane filter in the test vessel during inserting the membrane filter in the test vessel, and further comprising reinserting the test vessel, with the additional membrane filter still positioned therein, into the feed tank after testing the membrane filter for enzyme activity.

According to some other aspects of the present disclosure, a method for deactivating enzymes on a plurality of membrane filters positioned in filtration modules within a cleaning-in-place system (CIP system), including inserting a membrane filter of a same type as the plurality of membrane filters into a container that is separate from the CIP system, wherein the container is closable and permeable. The method further including inserting the container into a feed tank of the CIP system (CIP feed tank), such that the container will remain in the CIP feed tank submerged in fluid while fluids in the CIP feed tank will exit the CIP feed tank to travel throughout the CIP system. The method further including inserting an enzyme composition into the CIP feed tank for traveling through the CIP system, inserting an inactivator composition capable of deactivating the enzyme composition into the CIP feed tank for traveling through the CIP system after the insertion of the enzyme composition, such that the inactivator composition will reach the plurality of membrane filters positioned in filtration modules. The method further including removing the container from the CIP feed tank after insertion of the inactivator composition, removing the membrane filter from the container, and testing the membrane filter for enzyme activity instead of the plurality of membrane filters positioned in filtration modules for assessing deactivation of the enzyme composition on the plurality of membrane filters positioned in filtration modules within the CIP system.

According to some additional aspects of the present disclosure, the inactivator composition travels through the CIP system for at least thirty minutes.

According to some additional aspects of the present disclosure, the container is inert to both the enzyme composition and the inactivator composition.

According to some additional aspects of the present disclosure, the temperature of fluids in the CIP system during insertion of the enzyme composition and insertion of the inactivator composition is at least forty-eight-degrees Celsius.

According to some additional aspects of the present disclosure, the method further includes inserting a first intermediate rinse into the CIP feed tank between the insertion of the enzyme composition and the insertion of the inactivator composition.

According to some additional aspects of the present disclosure, the method further includes inserting a second intermediate rinse into the CIP feed tank after insertion of the inactivator composition and before removal of the container from the CIP feed tank.

According to some additional aspects of the present disclosure, the pH of fluids in the CIP system are between 9.5-10.0 during inserting of the enzyme composition.

According to some other aspects of the present disclosure, a method for cleaning-in-place a plurality of membrane filters positioned in filtration modules within a cleaning-in-place system (CIP system), which includes inserting pre-rinse in a feed tank of the CIP system (CIP feed tank) for traveling through the CIP system, and inserting a membrane filter of a same type as the plurality of membrane filters into a container that is separate from the CIP system, wherein the container is closable and permeable. The method further includes inserting the container into the CIP feed tank, such that the container will remain in the CIP feed tank while the pre-rinse and other fluids freely travel through the CIP system, and inserting a chelator into the CIP feed tank for traveling through the CIP system for reducing water hardness until water in the CIP system is about zero grains per gallon with respect to calcium ions. The method further includes reaching a temperature of at least 50-degrees Celsius for fluid in the CIP system, inserting lipase into the CIP feed tank for traveling through the CIP system after fluid in the CIP system has reached 50-degrees Celsius, inserting protease and a surfactant into the CIP feed tank for traveling through the CIP system for twenty to thirty minutes after the lipase has been inserted and run through the CIP system for forty-five to sixty minutes, and inserting a first intermediate rinse into the CIP feed tank for traveling through the CIP system to flush out the lipase, protease, and surfactant from the CIP system. The method further includes inserting an acidic composition of pH of less than 2.0 capable of deactivating lipase into the CIP feed tank for traveling through the CIP system after the first intermediate rinse, inserting a second intermediate rinse into the CIP feed tank for traveling through the CIP system to rinse out the acidic composition until fluid in the CIP system reaches a pH of between 6.0 to 7.0, removing the container from the CIP feed tank, removing a first sample from the membrane filter from the container, and testing the first sample for lipase activity.

According to some additional aspects of the present disclosure, the method further includes inserting the container back into the CIP feed tank with the membrane filter therein, and further inserting an alkaline composition into the CIP feed tank of pH greater than 11.0 for traveling through the CIP system for about thirty minutes, and after the about thirty minutes inserting a final rinse into the CIP feed tank for traveling through the CIP system to rinse all fluids from the CIP system.

According to some additional aspects of the present disclosure, the temperature of fluids in the CIP system are above forty-eight-degrees Celsius during inserting the acidic composition and during inserting the alkaline composition of the method of embodiment 18.

According to some additional aspects of the present disclosure, the method further includes removing the container from the CIP feed tank after the final rinse, removing a second sample from the membrane filter from the container, and testing the second sample for lipase activity, wherein if the second sample contains lipase activity then the method of embodiment 19 (including all steps of embodiments it depends from) is repeated.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

While multiple embodiments are disclosed, still other embodiments of the present invention will become apparent to those skilled in the art from the following detailed description, which shows and describes illustrative embodiments of the invention. Accordingly, the figures and detailed description are to be regarded as illustrative in nature and not restrictive.

### BRIEF DESCRIPTION OF THE FIGURES

Several embodiments in which the present disclosure can be practiced are illustrated and described in detail, wherein like reference characters represent like components throughout the several views. The drawings are presented for exemplary purposes and may not be to scale unless otherwise indicated.

FIG. 1A is a flow diagram of a method of cleaning membranes within a cleaning-in-place (CIP) system.

FIG. 1B is a flow diagram of an additional method of cleaning membranes within a cleaning-in-place (CIP) system.

FIG. 2 illustrates lipase interaction in a membrane.

FIG. 3A illustrates lipase in a liquid solution.

FIG. 3B illustrates lipase within a membrane.

FIG. 3C shows a scanning electron microscope (SEM) image of lipase within an exemplary membrane.

FIG. 4 shows a diagram of a simplified CIP system including a feed tank, a filtration module, and a test vessel positioned within the feed tank.

FIG. 5A shows a diagram depiction of the container of FIG. 4.

FIG. 5B shows the optional nature of portions of the test vessel of FIG. 4.

FIG. 6 shows an alternative set-up for introducing a test vessel into a CIP system.

FIG. 7 shows yet another set-up for introducing a test vessel into a CIP system.

Various embodiments of the enzymatic detergent compositions, methods of use, and methods of manufacture are described herein. Reference to various embodiments does not limit the scope of the invention. Figures represented herein are not limitations to the various embodiments according to the invention and are presented for exemplary illustration of the invention.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The embodiments of this invention are not limited to particular CIP systems and methods of cleaning the same, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a.” “an” and “the” can include plural referents unless the content clearly indicates otherwise. Further, all units, prefixes, and symbols may be denoted in their SI accepted forms.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 11/2, and 43/4 This applies regardless of the breadth of the range.

References to elements herein are intended to encompass any or all of their oxidative states and isotopes.

The term “about,” as used herein, refers to variation in the numerical quantity that can occur, for example, through typical measuring techniques and equipment, with respect to any quantifiable variable, including, but not limited to, mass, volume, time, distance, wave length, frequency, voltage, current, and electromagnetic field. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxy carbonyloxy, aryloxy, aryloxy carbonyloxy, carboxylate, alkylcarbonyl, arylcarbonyl, alkoxy carbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The terms “water soluble” and “water dispersible” as used herein, means that the ingredient is soluble or dispersible in water in the inventive compositions. In general, the ingredient should be soluble or dispersible at 25° C. concentration of between about 0.1 wt. % and about 15 wt. % of the water, more preferably at a concentration of between about 0.1 wt. % and about 10 wt. %.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

The methods and compositions described herein may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Purpose

Disclosed herein are systems and methods for determining deactivation of enzymes for membrane filters deep in a CIP system (typically housed in filtration modules) that are difficult to reach and/or replace including microfiltration, ultrafiltration, nanofiltration, or reverse osmosis or other membranes or membrane processes, typically utilized in dairy production or in a brewery or other industry application coping with fat soils.

Because these membrane filters are difficult to reach and can cause a cease-production spanning multiple days just to clean, check the condition of, and/or replace membranes within the filtration modules, the following systems and methods were developed to verify enzyme deactivation for the membrane filters positioned in the filtration modules without needing to cease production and take apart the CIP system to check within the filtration modules by checking for correct dosing of compositions inserted into the CIP system via testing filters placed in within a container known herein as a test vessel.

As will be described herein, cleaning-in-place can include various steps including the introduction of enzymes, and a separate step of deactivating the introduced-enzymes. By using a test vessel, separate from the CIP system, which includes a membrane filter of the same type as that stored within the filtration modules, operators can position the test vessel inside the CIP system to verify deactivation of enzymes without taking apart the CIP system (including the filtration modules).

### Enzymatic Detergent Compositions

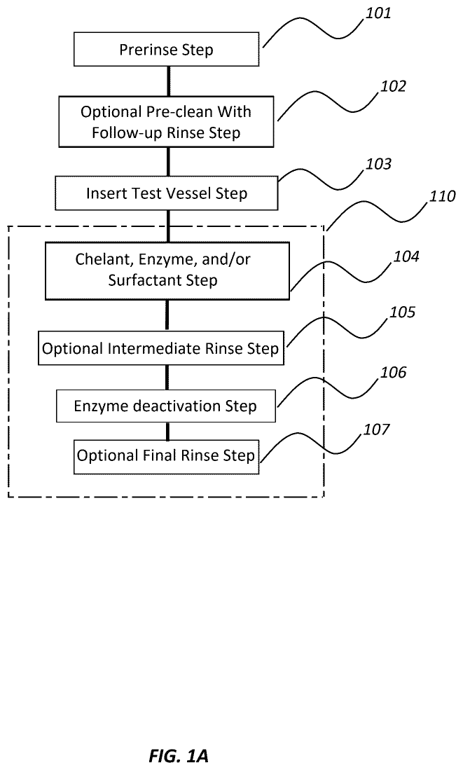

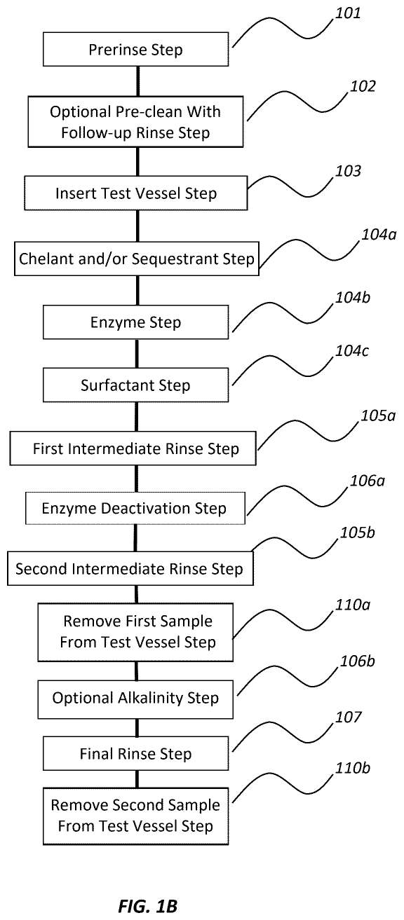

FIG. 1A shows a flow diagram of a method of cleaning membranes within a CIP system known as concurrent application. Generally, the concurrent application or method of FIG. 1A may include the steps of a prerinse step 101, an optional pre-clean with follow-up rinse step 102, an insert test vessel step 103, a chelant, enzyme, & surfactant step 104, an optional intermediate rinse step 105, an enzyme deactivation step 106, an optional final rinse step 107, and at any point after the insert test vessel step 103 a remove test vessel step 110 may be performed. In this regard, this “final” remove test vessel step 110 may not actually be the final step of the method of FIG. 1A. As such, it is understood that the remove test vessel step 110 may be performed in between any of steps 103-107 such as for example in between step 104 (chelant, enzyme, & surfactant step 104) and 105 (optional intermediate rinse step 105). This is in addition to the characteristic that the remove test vessel step 110 may occur mid-step throughout any of steps 103-107. For example, the remove test vessel step 110 may be performed mid-step 106 such that while the enzyme deactivation step 106 is underway the remove test vessel step 110 takes place before the enzyme deactivation step 106 has reached completion. Moreover, the remove test vessel step 110 may be performed any number of times. As such, noted by way of example and not of limitation, the remove test vessel step 110 may occur during the optional intermediate rinse step 105, after the optional intermediate rinse step 105, and during the enzyme deactivation step 106. It is understood that the remove test vessel step 110 includes testing a material positioned within a test vessel after removal (and before re-insertion into the CIP system should the test vessel be re-inserted) which will be discussed more herein.

### Membranes

The membranes can be microfiltration, ultrafiltration, nanofiltration, and/or reverse osmosis membranes. Microfiltration membranes can include, but are not limited to, Hydranautics SuPro, Synder LX, Synder FR, Alfa Laval GRM 0.1PP, Synder V0.1, Koch Dairy Pro MF-0.1, Alfa Laval FSM0.15, Alfa Laval GRM 0.2PP, Synder V0.2, Alfa Laval FSM0.45. Ultrafiltration membranes can include, but are not limited to, Koch Dairy Pro 5K, Koch HFK-131, Alfa Laval GR61PP, Alfa Laval GR60PP, Synder MK, Alfa Laval GR51PP. Synder MQ, Alfa Laval FS40PP, Synder LY, Synder PY, Synder BY, Koch, HFM-180). Preferably, the filtration membranes are Koch Dairy Pro 5K, Koch HFK-131, Alfa Laval GR61PP, or Alfa Laval GR60PP. The filtration membranes can contain polymers which include, for example, PES, PS, PVDF, PAN, PA, Cellulose, Celluloseacetate or the like. Preferably, the polymers include PES and PS. The filtration membranes can have an approximate molecular weight cut-off preferably from about 5 kDa to 5000 kDa. The filtration membranes can have an approximate pore size preferably from 0.0005 μm to 0.45 μm.

### Pre-Rinse

Preferably, the cleaning-in-place begins with a prerinse step 101. The pre-rinse can remove some soils from the membrane, typically loose soils. The rinse is preferably performed with water. The water can be tap water or a water that has been softened or polished by Reverse Osmosis (RO). The water can have a hardness of about 20 grains or less, preferably about 15 grains or less, more preferably about 10 grains or less, even more preferably 5 grains or less. Most preferably, the water is distilled water or RO. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 25° C. and 70° C., most preferably between 30° C. and 70° C.

Optional Pre-Clean with Follow-Up Rinse Step

Optionally, a membrane can be pre-cleaned with a membrane cleaning detergent in an optional pre-clean with follow-up rinse step 102. A membrane cleaning detergent can aid in removing some of the easier to clean soils from the membrane thereby allowing the methods disclosed herein to focus more on the difficult soils. Any suitable membrane cleaning detergent can be employed.

If a pre-clean and follow-up rinse step is performed, the follow-up rinse is performed to remove the membrane cleaning detergent. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 25° C. and 70° C., most preferably between 30° C. and 70° C. It is understood that the temperature may even be higher depending on the membrane specification.

### Insert Test Vessel Step

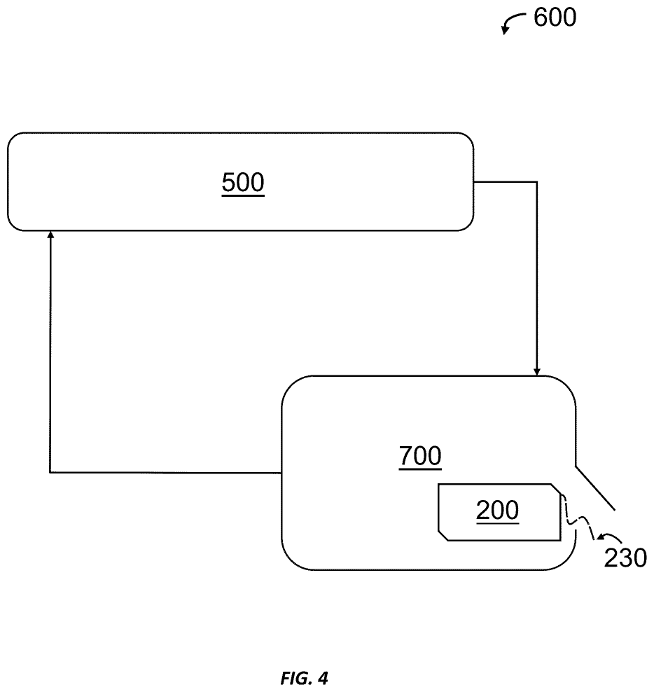

The test vessel 200 can be seen in FIGS. 4-7 and will be described in greater detail in conjunction with discussion of these figures. In this insert test vessel step 103, the test vessel 200 is inserted into the fluid of the CIP system such that a membrane filter 210 positioned within a container 220 of the test vessel 200 is submerged in fluid. To improve accuracy of enzyme detection on the membrane filter 210 later on in the sequence of steps, position the test vessel 200 such that the membrane filter 210 is always submerged in fluid until the test vessel 200 is ready for removal. This membrane filter 210 is preferably of the same type of membrane filter that can be found in filtration modules deep within the CIP system which are difficult to remove and run tests on. This does not preclude the possibility of using a membrane filter that is different from a plurality of membrane filters positioned in the filtration membrane system as different membrane filters can be used, especially if the membrane filters 210 in the test vessel 200 are of a variety that are more difficult to clean and deactivate enzyme than those positioned in the filtration modules. The membrane filter 210 in (and including) the test vessel 200 is easily insertable and removable to and from the CIP system 600, 610, 620 as opposed to membrane filters in the filtration modules.

Chelant, Enzyme, and/or Surfactant Step

The method of FIG. 1A includes inserting a chelant, enzyme, and/or surfactant step 104 concurrently for concurrent application. All may be inserted simultaneously to work towards the purpose of cleansing membrane filters positioned deep within a CIP system (FIG. 1B shows an example of how the application may be step by step application as opposed to concurrently and will be discussed later). Each of the chelant, enzyme, and/or surfactant will now be described under the term “enzyme composition” below. It is understood that the description below does not preclude the introduction of chelants, enzymes, and/or surfactants that are described with reference to FIG. 1B presented later.

### Enzyme Composition

The enzyme composition preferably comprises an amylase, a cellulase, a lipase, a protease, a cutinase, a peroxidase, a gluconase, or DNAse, or other dairy soil digesting enzymes also mixtures thereof; and optionally a buffer, chelant, and/or sequestrant.

Any lipase or mixture of lipases, from any source, can be used in the enzyme composition, provided that the selected lipase is stable in a pH range compatible with the type of membrane. For example, the lipase enzymes can be derived from a plant, an animal, or a microorganism such as a fungus or a bacterium. The lipase can be purified or a component of a microbial extract, and either wild type or variant (either chemical or recombinant).

The enzyme composition can further comprise a protease. Any protease or mixture of proteases, from any source, can be used in the enzyme composition, provided that the selected protease is stable in a pH range compatible with the type of membrane. For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant).

The enzyme composition can further comprise a surfactant. Preferred surfactants include, but are not limited to, nonionic surfactants, amphoteric surfactants, a sulfonated surfactant, or a mixture thereof. More preferred, the surfactant comprises an alkyl polyglucoside, an amine oxide, an alcohol ethoxylate, an alkoxylated block copolymer, a sulfonated surfactant, or a mixture thereof. Most preferred, the surfactant comprises an alkyl polyglucoside, an amine oxide, a sulfonated surfactant, or a mixture thereof.

The enzyme composition can further comprise a buffer. Preferably the buffer is selected based on the optimal pH for the enzyme(s) in the enzyme composition. Preferred buffers include those suitable for buffering the composition such that it maintains a pH between 7.5 and 12.5. Any suitable buffer achieving this pH can be utilized. In a preferred embodiment, the buffer comprises a carbonate-based buffer, including, but not limited to an alkali metal carbonate, sodium bicarbonate, or a mixture thereof. The amount of buffer included is the amount needed to retain a pH for optimal enzyme activity.

The enzyme composition can optionally comprise a chelant and/or sequestrant. As described herein, chelants include compounds that form water soluble complexes with metals. As described herein, sequestrants include compounds that form water insoluble complexes with metals.

Preferred chelants include aminocarboxylates, sodium tripolyphosphate, citrate (in their acid or salt form). Preferred aminocarboxylates include biodegradable aminocarboxylates. Examples of suitable biodegradable aminocarboxylates include: ethanoldiglycine, e.g., an alkali metal salt of ethanoldiglycine, such as disodium ethanoldiglycine (Na₂EDG); methylgylcinediacetic acid (MGDA), e.g., an alkali metal salt of methylgylcinediacetic acid, such as trisodium methylgylcinediacetic acid; ethylenediaminetetraacetic acid (EDTA); iminodisuccinic acid, e.g., an alkali metal salt of iminodisuccinic acid, such as iminodisuccinic acid sodium salt; N,N-bis-(carboxylatomethyl)-L-glutamic acid (GLDA), e.g., an alkali metal salt of N,N-bis(carboxylatomethyl)-L-glutamic acid, such as iminodisuccinic acid sodium salt (GLDA-Na₄); [S—S]-ethylenediaminedisuccinic acid (EDDS), e.g., an alkali metal salt of [S—S]-ethylenediaminedisuccinic acid, such as a sodium salt of [S—S]-ethylenediaminedisuccinic acid; 3-hydroxy-2,2′-iminodisuccinic acid (HIDS), e.g., an alkali metal salt of 3-hydroxy-2,2′-iminodisuccinic acid, such as tetrasodium 3-hydroxy-2,2′-iminodisuccinate.

Some examples of polymeric polycarboxy lates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

If included in the enzyme composition, the chelant and/or sequestrant is preferably in a concentration between about 10 ppm and about 10,000 ppm, more preferably between about 25 ppm and about 5,000 ppm, most preferably between about 50 ppm and about 2,500 ppm.

### Optional Intermediate Rinse Step

Following the chelant, enzyme, and/or surfactant step 104, the membrane may rinsed by inserting water into the CIP feed tank to remove any excess enzyme composition in a second intermediate rinse step 105. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO (reverse osmosis) water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 30° C. and 70° C., most preferably between 50° C. and 70° C. It is understood that the temperature may even be higher depending on the membrane specification.

### Enzyme Deactivation Step

A focus of the present disclosure is directed towards the enzyme deactivation step 106. Any residual enzyme on the membrane can be deactivated by contacting the membrane with an inactivator composition. The methods and systems can comprise an inactivator composition. Various inactivator compositions and inactivation steps can be performed depending on the target of the inactivation. For example, some enzymes can be inactivated by an oxidizer while lipases have stability against oxidation. Some proteases are susceptible to inactivation from alkaline compositions while lipases are generally resistant to alkaline deactivation. Thus, it should be appreciated that the specific inactivation compound can be selected based on the cleaning composition employed in the system, but the methods and systems described herein are not limited to the inactivation compound. Accordingly, preferred inactivation compounds are listed below, however, this list is not exhaustive and the methods and systems are not limited to the list. Preferred inactivation compositions can include, but are not limited to, an acid source, an alkaline source, an oxidizer (including, but not limited to sodium hypochlorite), an anionic surfactant (more preferably an acidic anionic surfactant), an alcohol, a polyol, or a combination thereof.

One specific example of deactivating is the deactivation of lipase in which it can be deactivated under the following conditions: pH of either below 2.0 or above 10.8; time 20 minutes; temperature >48 degrees Celsius; and keeping all loops active during operation of a cleaning in place.

### Optional Final Rinse Step

Following the enzyme deactivation step 106, the membrane may rinsed by inserting water into the CIP feed tank to remove any excess inactivator composition and/or surfactant in a second intermediate rinse step 107. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO (reverse osmosis) water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 30° C. and 70° C.), most preferably between 50° C. and 70° C. It is understood that the temperature may even be higher depending on the membrane specification.

Remove Sample from Test Vessel Step

As mentioned earlier, the remove test vessel step 110 may happen at any point after the insert test vessel step 103. An operator may remove the test vessel 200 (discussed in greater detail with relation to FIGS. 4-7) from the CIP system 600, 610, 620 and take out a sample from the membrane vessel 210 that was positioned within the container 220 after the enzyme inactivation step and the rinse. In this regard, either multiple membrane filters 210 exist within the container 220 and one or more membrane filters 210 are removed, or only a portion of a larger membrane filter 210 is removed, such that membrane filter 210 remains in the container 220. After removing the sample from the test vessel 200, the test vessel 200 may be reinserted into the CIP system 600, 610, 620. For improved accuracy of mimicking conditions of membrane filters deep in the CIP system, it is preferred that removal of the test vessel 200 happens at an end of any of steps 104-107 rather than mid-step so as to more accurately mimic conditions in the filtration module(s) that are positioned deep in the CIP system.

The first sample is handled with care and sterile gloves and/or instruments so as to preserve a condition of the membrane filter 210 that was taken for the first sample. This is important so as to reduce any inaccurate readings during testing. Testing is done with an intent to check for residue composition disposed on the membrane filter that was positioned in the test vessel 200. Thus, should the test vessel 200 be removed during or after the chelant, enzyme, and/or surfactant step 104, the purpose of testing would be to check for surface activity of any chelant, enzyme, and/or surfactant on the membrane filter positioned within the test vessel 200. Should the test vessel 200 be removed from the CIP system after the inactivator composition has been applied to the CIP system, the purpose of testing would be to check for any remaining enzyme activity (i.e., was the inactivator composition successful at deactivating all of the enzyme in question). The first sample may then be tested with a GlycoSpot test among other options. A GlycoSpot test instrument for determining enzyme Activity may be purchased from GlycoSpot, Østmarken 9, 2860 Soborg, Denmark, optionally through the website https://www.glycospot.dk. It is understood that testing can be done to check for any remaining surfactant on the membrane surface in addition to success and/or failure in deactivating enzymes.

It is understood that multiple samples of membrane filters can be taken from the test vessel 200 in this remove sample from test vessel step 110. This simply requires that more of the membrane filter 210 is positioned within the test vessel 200 to begin with.

If the testing results in a showing of no enzyme activity or surfactants on the samples, then dosing/rinse was performed correctly and the CIP procedure may end. If for example testing results in a finding that enzyme activity remains, then this is an indicator that more of the inactivator composition must be applied to the CIP system in order to ensure full deactivation of enzymes for membranes deep within the CIP system (those within filtration modules, and not so easily accessible as the test sample membrane filters placed within the test vessel 200). Or, for example, testing of the sample from the removed test vessel 200 may show that an abundance of inactivator composition remains on a surface of the membrane filter. In such a scenario, this would mean that more rinse water needs to be inserted into the CIP system so as to fully rinse the membrane filters positioned deep within the CIP system.

### Note

For the introduction of all liquids into the CIP system, note that the CIP system is a loop such that all liquids introduced into the CIP feed tank may return to the CIP feed tank after being run through the CIP system. However, for given liquids it is preferred that they not re-circulate through the system, the main liquid to be run through without recirculation being water for any and/or all rinse steps. In this regard, the rinse steps are designed to remove other compositions that have been introduced into the CIP system, and the removal is better facilitated by draining the water that has been introduced into the CIP system rather than having it return to the CIP feed tank for additional rounds of circulation. This is for the reason that once composition has been removed from a filter deep within the CIP system (surfactant, enzymes, etc.) with the rinse water, there is no reason to rerun the rinse water carrying that removed-composition back to the filters as the intent is to have the removed-composition remain removed. This draining of the rinse water however does not follow the same logic as the introduction of many other liquids such as an enzyme deactivator composition. In this regard, the intent with the enzyme deactivator composition (and other liquids intended to be recirculated rather than immediately drained) is to ensure that it has reached all corners of the CIP system. Thus, the liquid is recirculated and recirculated within the CIP system after being introduced into the CIP feed tank until it is decided that enough time has elapsed. The given time varies per CIP system and includes various factors such as size of the CIP system, temperature of the liquid composition being run through the CIP system, age of the membrane filters positioned deep in the CIP system, and deciding on an exactly correct amount of time to recirculate a liquid through the CIP system will be determined after testing the given system which may include taking it apart and taking samples during this first testing so as to know for future CIP cleanings what degree of saturation is reached after x-amount of time.

FIG. 1B shows a flow diagram of a method of cleaning membranes within a CIP system known as top-up procedure and will be explained as more precise steps than the concurrent application of FIG. 1A given the greater detail of which steps come when rather than the notion of inserting everything into the CIP system at once. Preferably the membranes of a CIP system within filtration modules can be cleaned with a stepwise cleaning regime employing a prerinse step 101, an optional preclean with follow-up rinse step 102, an insert test vessel step 103, a chelant and/or sequestrant step 104a, an enzyme step 104b, a surfactant step 104c, a first intermediate rinse step 105a, an enzyme deactivation step 106a, a second intermediate rinse step 105b, a remove first sample from test vessel step 110a, an optional alkalinity step 106b, a final rinse step 107, and a remove second sample from test vessel step 110b as illustrated in FIG. 1B. More preferably, the membranes cleaned in the enzyme step 104b are cleaned with an enzyme composition comprising a carrier, an enzyme and a buffer. Most preferably the enzyme composition comprises water, lipase, protease, buffer, and a chelant. In the enzyme deactivation step 106a the enzyme deactivator can comprise an acidic composition wherein the acidic composition comprises an acid, an acidic anionic surfactant or a mixture thereof. More preferably, the membranes cleaned in the alkalinity step 106b are cleaned with an alkaline composition. As opposed to the concurrent application which includes the alkalinity step 106b in the enzyme deactivation step 106, this alkalinity step 106b is not to be understood as precluding alkaline from the enzyme deactivation step 106a, rather just that it may be preferred to have an alkalinity step 106b, or an additional alkalinity step 106b, after there has been an intermediate rinse step 105b. Most preferably, the alkaline composition comprises an alkali metal hydroxide, alkali metal carbonate, or mixture thereof. The steps of the methods disclosed herein are further illustrated in FIG. 1B and described below. The steps of the methods may contact the membranes from about 1 minute to about 240 minutes, from about 5 minutes to about 180 minutes, from about 15 minutes to about 180 minutes, from about 5 minutes to about 180 minutes, most preferably between about 15 minutes and 180 minutes. In a preferred embodiment, the enzymatic step is for a time between about 1 minute and about 150 minutes, more preferably about 5 minutes to about 140 minutes, still more preferably between about 10 minutes and about 130 minutes; most preferably between about 15 minutes and about 120 minutes. In a preferred embodiment, the surfactant step is for a time between about 1 minute and about 90 minutes, more preferably between about 2 minutes and about 75 minutes, most preferably between about 5 minutes and about 60 minutes.

Fat is a critical challenge in dairy production. Studies of cleaned and uncleaned field membranes showed a factor of 10 times higher fouling load of fats, especially high-melting triglycerides compared to protein foulants present on the membranes. Fat and protein soils are difficult to clean during a cleaned-in-place regime, and due to the higher melting points of the fat far beyond the cleaned-in place temperature, high melting fat accumulates over the membrane's lifetime. Incomplete removal of membrane fouling impacts membrane production performance and is a significant factor in overall membrane health. Triglyceride fats are challenging to remove and build up on the membrane over time. Triglyceride fats can be degraded via a catalytic reaction with lipase. The lipase molecule unfolds the three-dimensional structure of the triglyceride fats, which creates a loss of active sites, as can be seen by the diagram below.

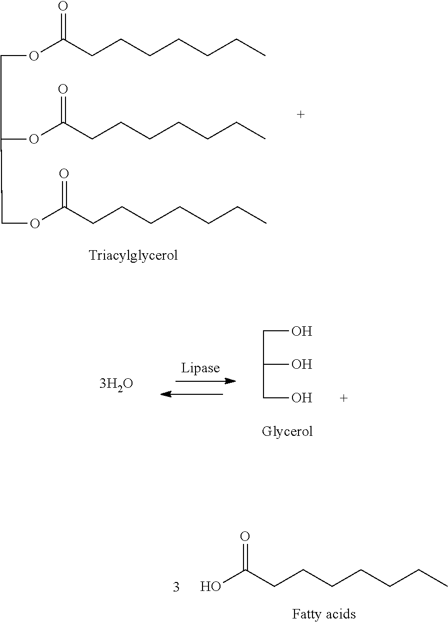

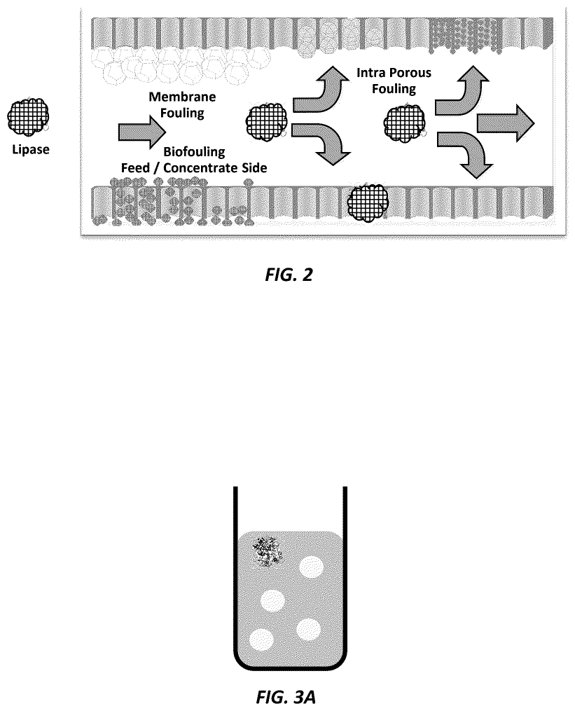

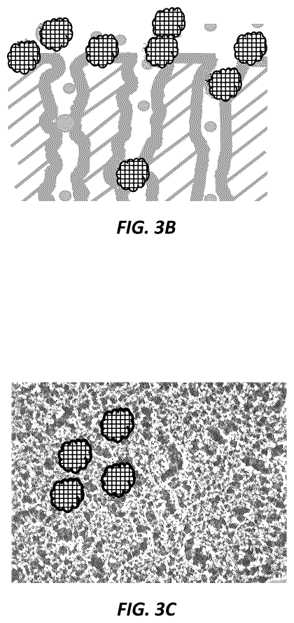

FIG. 2 demonstrates that lipases, although able to remove the fats from the membranes, also stick to the membrane surface, as well as in the pores. FIG. 3C shows an SEM surface picture of a microfiltration membrane. Inactivation of the lipases is more difficult in a membrane filtration system (FIG. 3B) compared to a liquid solution (FIG. 3A) scenario. In the upper membrane surface, lipases interact with the membrane pores. Lipolytic enzymes are designed to be stable in high alkaline formulations. Current cleaning regimes do not completely remove all the fouling components from all membrane types and do not address the full fouling phenomena. Lipases are surface active and stick to the membrane surface and cannot be rinsed away with water only. Oxidizers likewise cannot fully inactivate lipase (stability against oxidation).

The lipase molecule is approximately 30 kDa (see, Izrael-Zivkovic, Lidija T et. al, Enzymatic characterization of 30 kDa lipase from Pseudomonas aeruginosa ATCC 27853, J Basic Microbiol, 49 (5): 452-62. doi: 10.1002/jobm.200800229. PMID: 19455522 (October 2009)). Therefore, based purely on size, it will pass or permeate most microfiltration membranes, whereas it would be rejected by ultrafiltration, nanofiltration, and reverse osmosis membranes. If lipase can enter the structure of a microfiltration membrane, the larger internal pore area interacts with the lipase causing more lipase molecules sticking to the membrane, which also makes an inactivation/rinse out more difficult. For ultrafiltration membranes, lipase could interact with the pores on the membrane surface. As the membrane surface becomes smoother (i.e., smaller pore size) lipase interaction risk with the membranes decreases.

### Membranes

The membranes can be microfiltration, ultrafiltration, nanofiltration, and/or reverse osmosis membranes. Microfiltration membranes can include, but are not limited to, Hydranautics SuPro, Synder LX, Synder FR, Alfa Laval GRM 0.1PP, Synder V0.1, Koch Dairy Pro MF-0.1, Alfa Laval FSM0.15, Alfa Laval GRM 0.2PP, Synder V0.2, Alfa Laval FSM0.45. Ultrafiltration membranes can include, but are not limited to, Koch Dairy Pro 5K, Koch HFK-131, Alfa Laval GR61PP, Alfa Laval GR60PP, Synder MK, Alfa Laval GR51PP, Synder MQ, Alfa Laval FS40PP, Synder LY, Synder PY, Synder BY, Koch, HFM-180. Preferably, the filtration membranes are Koch Dairy Pro 5K, Koch HFK-131, Alfa Laval GR61PP, or Alfa Laval GR60PP. The filtration membranes can contain polymers which include, for example, PES, PS, PVDF, PAN, PA, Cellulose, Celluloseacetate or the like. Preferably, the polymers include PES and PS. The filtration membranes can have an approximate molecular weight cut-off preferably from about 5 kDa to 5000 kDa. The filtration membranes can have an approximate pore size preferably from 0.0005 μm to 0.45 μm.

### Pre-Rinse

Preferably, the cleaning-in-place begins with a prerinse step 101. The pre-rinse can remove some soils from the membrane, typically loose soils. The rinse is preferably performed with water. The water can be tap water or a water that has been softened or polished by Reverse Osmosis (RO). The water can have a hardness of about 20 grains or less, preferably about 15 grains or less, more preferably about 10 grains or less, even more preferably 5 grains or less. Most preferably, the water is distilled water or RO. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C.), more preferably between 25° C. and 70° C., most preferably between 30° C. and 70° C. It is understood that the temperature may even be higher depending on the membrane specification.

Optional Pre-Clean with Follow-Up Rinse Step

Optionally, a membrane can be pre-cleaned with a membrane cleaning detergent in an optional pre-clean with follow-up rinse step 102. A membrane cleaning detergent can aid in removing some of the easier to clean soils from the membrane thereby allowing the methods disclosed herein to focus more on the difficult soils. Any suitable membrane cleaning detergent can be employed.

If a pre-clean and follow-up rinse step is performed, the follow-up rinse is performed to remove the membrane cleaning detergent. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 25° C. and 70° C., most preferably between 30° C. and 70° C.

### Insert Test Vessel Step

The test vessel 200 can be seen in FIGS. 4-7 and will be described in greater detail in conjunction with discussion of these figures. In this insert test vessel step 103, the test vessel 200 is inserted into the fluid of the CIP system such that a membrane filter 210 positioned within a container 220 of the test vessel 200 is submerged in fluid. To improve accuracy of enzyme detection on the membrane filter 210 later on in the sequence of steps, position the test vessel 200 such that the membrane filter 210 is always submerged in fluid until the test vessel 200 is ready for removal. This membrane filter 210 is preferably of the same type of membrane filter that can be found in filtration modules deep within the CIP system which are difficult to remove and run tests on. This does not preclude the possibility of using a membrane filter that is different from a plurality of membrane filters positioned in the filtration membrane system as different membrane filters can be used, especially if the membrane filters 210 in the test vessel 200 are of a variety that are more difficult to clean and deactivate enzyme than those positioned in the filtration modules. The membrane filter 210 in (and including) the test vessel 200 is easily insertable and removable to and from the CIP system 600, 610, 620 as opposed to membrane filters in the filtration modules.

Chelant and/or Sequestrant Step

The enzyme composition can optionally comprise a chelant and/or sequestrant for the chelant and/or sequestrant step 104a. As described herein, chelants include compounds that form water soluble complexes with metals. As described herein, sequestrants include compounds that form water insoluble complexes with metals.

Removing metals, especially calcium from the fluid within the CIP system improves performance of the enzymes to be introduced (lipase, protease, amylase, etc.) against cleaning the membrane filters.

Preferred chelants include aminocarboxylates, sodium tripolyphosphate, citrate (in their acid or salt form). Preferred aminocarboxylates include biodegradable aminocarboxylates. Examples of suitable biodegradable aminocarboxylates include: ethanoldiglycine, e.g., an alkali metal salt of ethanoldiglycine, such as disodium ethanoldiglycine (Na₂EDG); methylgylcinediacetic acid (MGDA), e.g., an alkali metal salt of methylgylcinediacetic acid, such as trisodium methylgylcinediacetic acid; ethylenediaminetetraacetic acid (EDTA); iminodisuccinic acid, e.g., an alkali metal salt of iminodisuccinic acid, such as iminodisuccinic acid sodium salt; N,N-bis-(carboxylatomethyl)-L-glutamic acid (GLDA), e.g., an alkali metal salt of N,N-bis(carboxylatomethyl)-L-glutamic acid, such as iminodisuccinic acid sodium salt (GLDA-Na₄); [S—S]-ethylenediaminedisuccinic acid (EDDS), e.g., an alkali metal salt of [S—S]-ethylenediaminedisuccinic acid, such as a sodium salt of [S—S]-ethylenediaminedisuccinic acid; 3-hydroxy-2,2′-iminodisuccinic acid (HIDS), e.g., an alkali metal salt of 3-hydroxy-2,2′-iminodisuccinic acid, such as tetrasodium 3-hydroxy-2,2′-iminodisuccinate.

Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

If included, the chelant and/or sequestrant is preferably in a concentration between about 10 ppm and about 10,000 ppm, more preferably between about 25 ppm and about 5,000 ppm, most preferably between about 50 ppm and about 2,500 pm.

### Enzyme Step

The membrane is contacted with one or more of an enzyme composition in an enzyme step 104b. The enzyme composition can comprise a carrier, and an enzyme. The carrier is preferably water. The water can be tap water, distilled water, or RO (reverse osmosis) water. The water can have a hardness of about 20 grains or less, preferably about 15 grains or less, more preferably about 10 grains or less, even more preferably 5 grains or less, but most preferably about 0 grains. This is to prevent calcium from interfering with enzyme activity on membrane filters. Tap water can be used, room temperature water can used, or heated water can be used so long as it does not exceed the temperature guidelines for the particular membrane. Preferably, the enzyme composition further comprises a chelant. The amount of chelant can be influenced by the hardness of the water.

The pH of the enzyme composition is preferably from about 7.5 to about 11.0, more preferably from about 8.0 to about 10.5, most preferably from about 9 to about 10.

The temperature of the enzyme composition can be any temperature for which the membrane is compatible. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 30° C. and 70° C., most preferably between 50° C. and 70° C. It is understood that the temperature may even be higher depending on the membrane specification.

### Lipase

The enzyme composition comprises a lipase. Any lipase or mixture of lipases, from any source, can be used in the enzyme composition, provided that the selected lipase is stable in a pH range compatible with the type of membrane. For example, the lipase enzymes can be derived from a plant, an animal, or a microorganism such as a fungus or a bacterium. The lipase can be purified or a component of a microbial extract, and either wild type or variant (either chemical or recombinant).

Preferred lipase enzymes include, but are not limited to, the enzymes derived from a Pseudomonas, such as Pseudomonas stutzeri ATCC 19.154, or from a Thermomyces, such as Thermomyces lanuginosus (typically produced recombinantly in Aspergillus oryzae). Most preferably, the lipase comprises a variant of the wild-type Thermomyces lanuginosus lipase and has at least 90% sequence identity to SEQ ID NO 1:

EVSQDLENQF NLFAQYSAAA YCGKNNDAPA GTNITCTGNA
CPEVEKADAT FLYSFEDSGV GDVTGFLALD NTNKLIVLSF
RGSRSIENWI GNLNFDLKEI NDICSGCRGH DGETSSWRSV
ADTLRQKVED AVREHPDYRV VETGHSLGGA LATVAGADLR
GNGYDIDVES YGAPRVGNRA FAEFLTVQTG GTLYRITHTN
DIVPRLPPRE FGYSHSSPEY WIKSGTLVPV RRRDIVKIEG
IDATGGNNQP NIPDIPAHLW YFGLIGTCL

### Protease

The enzyme composition can further comprise a protease. Any protease or mixture of proteases, from any source, can be used in the enzyme composition, provided that the selected protease is stable in a pH range compatible with the type of membrane. For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant).

The pH of the enzyme composition is preferably from about 7.5 to about 11.0, more preferably from about 8.0 to about 10.5, most preferably from about 8.5 to about 9.5.

The temperature of the enzyme composition can be any temperature for which the membrane is compatible. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 30° C. and 70° C., most preferably between 50° C. and 70° C. It is understood that the temperature may even be higher depending on the membrane specification.

### Surfactant Step

The membrane is contacted with a surfactant composition in a surfactant step 104c. The surfactant composition comprises a carrier and a surfactant. The carrier is preferably water. The water can be tap water, distilled water, or RO water. The water can have a hardness of about 20 grains or less, preferably about 15 grains or less, more preferably about 10 grains or less, even more preferably 5 grains or less. Tap water can be used, room temperature water can used, or heated water can be used so long as it does not exceed the temperature guidelines for the particular membrane. In a preferred embodiment, the surfactant composition further comprises additional protease and/or additional buffer. The proteases and buffers described above are appropriate for the surfactant composition. The protease can be the same as that included in the enzyme step or a different protease than used in the enzyme step.

### Surfactant

The surfactant composition comprises a surfactant. Preferred surfactants include, but are not limited to, nonionic surfactants, amphoteric surfactants, a sulfonated surfactant, or a mixture thereof. More preferred, the surfactant comprises an alkyl polyglucoside, an amine oxide, an alcohol ethoxylate, an alkoxylated block copolymer, a sulfonated surfactant, or a mixture thereof. Most preferred, the surfactant comprises an alkyl polyglucoside, an amine oxide, a sulfonated surfactant, or a mixture thereof.

### Amine Oxide

Amine oxides are tertiary amine oxides corresponding to the general formula:

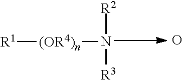

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 18 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Preferred amine oxides can include those selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl) amine oxide, 3,6,9-trioctadecyldimethylamine oxide and 3-dodecoxy-2-hydroxypropyldi-(2-hydroxyethyl) amine oxide.

### Nonionic Surfactants

Preferred nonionic surfactants include, but are not limited to, block copolymers, alcohol alkoxylates, alkoxylated surfactants, reverse EO/PO copolymers, alkylpolyglucosides, alkoxylated amines, fatty acid alkoxylates, fatty amide alkoxylate, alkanoates, and combinations thereof.

Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties.

Preferred liquid nonionic surfactants include, but are not limited to:

A. Block polyoxypropylene-polyoxyethylene polymeric compounds based upon propylene glycol, ethylene glycol, glycerol, trimethylolpropane, and ethylenediamine as the initiator reactive hydrogen compound.

B. Condensation products of one mole of a saturated or unsaturated, straight or branched chain alcohol having from about 6 to about 24 carbon atoms with from about 3 to about 50 moles of ethylene oxide. The alcohol moiety can comprise, consist essentially of, or consist of mixtures of alcohols in the above delineated carbon range or it can consist of an alcohol having a specific number of carbon atoms within this range, or it can be a guerbet alcohol ethoxylate.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions containing lipase enzymes because of potential incompatibility.

C. The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

D. Suitable nonionic surfactants suitable for use with the compositions of the present invention include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, capped alcohol alkoxylates, and mixtures thereof.

E. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule.

F. Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

G. Suitable nonionic surfactants also include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N{(EO)_{w}H}{(EO)_{z}H} in which R²⁰ is as defined above, vis 1 to 20 (e.g., 1, 2, 3, or 4 (preferably 2)), and w and z are independently 1-10, preferably 2-5.

H. Suitable nonionic surfactants also include fatty acid amide alkoxylates. Preferably such surfactants include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

I. Suitable nonionic surfactants also include nonionic alkanoates. Suitable alkanoates are nonionic esters or salts thereof formed from the reaction of alkanoic acid and an alkanol.

J. Suitable alkylpolyglucosides include quaternized sugar-derived surfactants including a quaternized alkyl polyglucoside or a polyquaternized alkyl polyglucoside, and the like. The quaternary functionalized alkyl polyglucoside is a naturally derived cationic surfactant from alkyl polyglucosides and has a sugar backbone. Quaternary functionalized alkyl polyglucosides have the following representative formula:

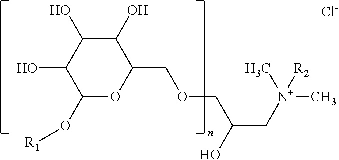

wherein R₁ is an alkyl group having from about 1 to about 22 carbon atoms, and R₂ is CH₃(CH₂)_{n′} where n′ is an integer ranging from 0-21. Examples of suitable quaternary functionalized alkyl polyglucosides components which can be used in the cleansing compositions according to the present invention include those in which the R₁ alkyl moiety contains primarily about 10-12 carbon atoms, the R₂ group is CH₃ and n is the degree of polymerization of 1-2.

A polyquaternary alkyl polyglucoside is naturally derived from alkyl polyglucosides and has a sugar backbone. Polyquaternary alkyl polyglucosides have the following representative formula:

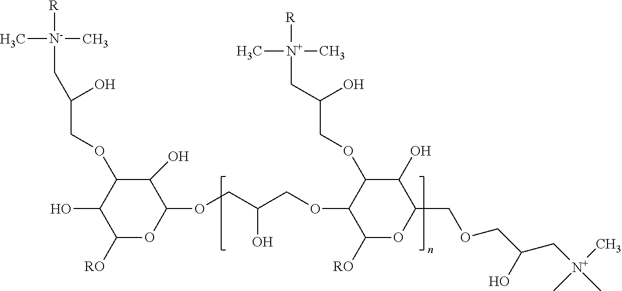

wherein R is an alkyl group having from about 6 to about 22 carbon atoms and n is an integer ranging from 4 to 6. Examples of suitable polyquaternary functionalized alkyl polyglucosides which can be used in the compositions include those in which the R alkyl moiety contains from about 8 to about 12-carbon atoms. In a preferred embodiment the quaternary functionalized alkyl poly glucoside contains primarily about 10-12 carbon atoms.

### Sulfonated Surfactant

The surfactant composition can comprise a sulfonated surfactant. Preferred sulfonated surfactants include sodium capryl sulfonate, sodium lauryl sulfate, linear alkyl benzene sulphonates, sodium dodecyl benzene sulfonate, or a mixture thereof.

The pH of the surfactant composition is preferably from about 7.5 to about 11.5, more preferably from about 8.0 to about 11.0, most preferably from about 8.5 to about 10.5.

The temperature of the surfactant composition can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 30° C. and 70° C., most preferably between 50° C. and 70° C. It is understood that the temperature may even be higher depending on the membrane specification.

### Note

It is noted that the chelator and/or sequestrant step 104a, the enzyme step 104b, and the surfactant step 104c can be mixed and separated in various ways. Namely, the enzyme step 104b can be broken separately into a lipase step and then a protease step or vice-a-versa, or simply be combined and be the enzyme step 104b. Another example includes breaking the enzyme step 104b into only a lipase step and combining the protease step with the surfactant step 104c such that the steps would be: lipase step and then protease-plus-surfactant step. Or yet another example may be lipase-plus-protease step and then protease-plus-surfactant step, such that an extended dose of protease is applied to the CIP system, or different variations of protease are applied one after the other. Yet another example can include combining the chelant step 104a with both of the enzyme step and the surfactant step such that through both of the enzyme 104b and surfactant 104c steps, the fluid of the system is being chelated.

In a preferred embodiment the chelator step 104a is applied by inserting chelant into a feed tank 700 of the CIP system before either of the enzyme or surfactant steps to reduce the water hardness to about zero grain. Then, the enzyme step 104b comprising a lipase-plus-protease Step is applied to the CIP system by inserting the composition into the CIP system and having it run for about 45-60 minutes, while a chelator is continuously applied to the CIP system. After the 45-60) minutes, chelant is still applied to the CIP system and a step of protease-plus-surfactant is applied to the CIP system for about 20-30 minutes. Following application of the protease-plus-surfactant, a first intermediate rinse follows which will now be described.

### First Intermediate Rinse Step

Following the surfactant cleaning step, the membrane is rinsed to remove any excess enzyme, surfactant, buffer, and chelant in a first intermediate rinse step 105a. The rinse is preferably performed with water. The water can be tap water or a water that has been softened, preferably RO water or deionized water. The water can have a hardness of about 20 grains or less, preferably about 15 grains or less, more preferably about 10 grains or less, even more preferably 5 grains or less. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 30° C. and 70° C., most preferably between 50° C. and 70° C. It is understood that the temperature may even be higher depending on the membrane specification.

### Enzyme Deactivation Step

A focus of the present disclosure is directed towards the enzyme deactivation step 106a. Any residual enzyme on the membrane can be deactivated by contacting the membrane with an inactivator composition. The methods and systems can comprise an inactivator composition. Various inactivator compositions and inactivation steps can be performed depending on the target of the inactivation. For example, some enzymes can be inactivated by an oxidizer while lipases have stability against oxidation. Some proteases are susceptible to inactivation from alkaline compositions while lipases are generally resistant to alkaline deactivation. Thus, it should be appreciated that the specific inactivation compound can be selected based on the cleaning composition employed in the system, but the methods and systems described herein are not limited to the inactivation compound. Accordingly, preferred inactivation compounds are listed below, however, this list is not exhaustive and the methods and systems are not limited to the list. Preferred inactivation compositions can include, but are not limited to, an acid source, an alkaline source, an oxidizer (including, but not limited to sodium hypochlorite), an anionic surfactant (more preferably an acidic anionic surfactant), an alcohol, a polyol, or a combination thereof.

Should the inactivator composition comprise an acid, an acidic anionic surfactant, or a mixture thereof, the pH of the acidic composition is preferably about 2.5 or lower, more preferably about 2.4 or lower, still more preferably about 2.3 or lower, even more preferably about 2.2 or lower, yet more preferably about 2.1 or lower, most preferably about 2.0 or lower or lower than 2.0. Preferably the acidic composition is applied to the CIP system for 15 to 45 minutes, and most preferably between about 30 to 40 minutes.

One specific example of deactivating is the deactivation of lipase in which it can be deactivated under the following conditions: pH of either below 2.0 or above 10.8; time 20 minutes; temperature >48 degrees Celsius; and keeping all loops active during operation of a cleaning in place.

### Acidic Anionic Surfactants

The acidic composition can comprise an acidic anionic surfactant. Anionic surfactants are surface active substances which are categorized by the negative charge on the hydrophile; or surfactants in which the hydrophilic section of the molecule carries no charge unless the pH is elevated to the pKa or above (e.g. carboxylic acids). Some anionic surfactants have an acid pH in solution. Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility.

Preferred acidic anionic surfactants, include, but are not limited to, sulfonated surfactants include alkyl sulfonates, the linear and branched primary and secondary alkyl sulfonates, and the aromatic sulfonates with or without substituents. In an aspect, sulfonates include sulfonated carboxylic acid esters. In an aspect, suitable alkyl sulfonate surfactants include C₈-C₂₂ alkylbenzene sulfonates, or C₁₀-C₂₂ alkyl sulfonates. In an exemplary aspect, the acidic anionic surfactant comprises an alkyl sulfonate surfactant, most preferably linear alkyl benzene sulfonic acid (LAS). In a further embodiment, the acidic anionic surfactant may alternatively or additionally include diphenylated sulfonates, and/or sulfonated oleic acid. Most preferred acidic anionic surfactants include, but are not limited to, C₈-C₂₂ alkylbenzene sulfonates, sulfonated oleic acid, a sulfosuccinate, a secondary alkane sulfonate, or mixtures thereof.

### Acid

The acidic composition can comprise an acid. Preferred acids include organic acids, nitric acid, phosphoric acid, methanesulfonic acid, and mixtures thereof. Preferred organic acids include, but are not limited to, formic acid, acetic acid, glycolic acid, glyoxylic acid, oxalic acid, propionic acid, lactic acid, glyceric acid, malonic acid, tartronic acid, glycidic acid, butanoic acid, 2-methylpropanoic acid, citric acid, and mixtures thereof. Strong acids are not suitable, including, but not limited to, sulfuric acid, hydrochloric acid, and hydrofluoric acid. More preferred acids include nitric acid, phosphoric acid, methanesulfonic acid, lactic acid, citric acid, and mixtures thereof. Most preferred acids include citric acid, lactic acid, and mixtures thereof.

The temperature of the acidic composition can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. For a high temperature membrane, preferably the temperature of the rinse water is between 20° C. and 70° C., more preferably between 30° C. and 70° C., most preferably between 50° C. and 70° C. It is understood that the temperature may even be higher depending on the membrane specification.

### Second Intermediate Rinse Step

Following the enzyme deactivation step, the membrane is rinsed by inserting water into the CIP feed tank to remove any excess inactivator composition and/or surfactant in a second intermediate rinse step 105b. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO (reverse osmosis) water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 30° C. and 70° C., most preferably between 50° C. and 70° C.

Remove First Sample from Test Vessel Step

Following the second intermediate rinse step 105b, the operator can remove the test vessel 200 from the CIP system 600, 610, 620 and take out a sample from the membrane filter(s) 210 that was positioned within the container 220 after the enzyme inactivation step and the rinse. In this regard, either multiple membrane filters 210 exist within the container 220 and one or more membrane filters 210 are removed, or only a portion of a larger membrane filter 210 is removed, such that membrane filter 210 remains in the container 220. After removing the first sample from the test vessel 200, the test vessel 200 is reinserted into the CIP system 600, 610, 620. This is referred to as the remove first sample from test vessel step 110a. For improved accuracy of mimicking conditions of membrane filters deep in the CIP system in filtration modules that are not easily accessible, it is preferred that a full rinse is applied to the test vessel 200 before removal of the test vessel 200 to most accurately mimic conditions in the filtration module(s) that are positioned deep in the CIP system. All fluids during CIP recirculation and rinse should at least flow past the test vessel 200 while the test vessel 200 is inserted to mimic CIP and rinse processes for filtration membranes deep in the CIP system that are not easily accessible or easily removed. Because the membrane filter 210 is immersed in the solutions inserted into the CIP feed tank 700, the solution can penetrate the membrane filters 210 substantially orthogonal from a first side, setting up a worst case scenario for fouling to build up as a layer on the first side of the membrane filter 210 (as opposed to membrane soaking without flow, in which immersion of the membrane filter 210 without active penetration, without exiting permeate, and in a non-flowing solution, could allow the solution to penetrate and break down any buildup on the first side of the membrane filter 210 surface rather than build up a layer of fouling thus potentially not mimicking conditions of filtration modules deep in the CIP system. Similarly, a cross-flow scenario can also work against fouling buildup in which solution flows past a surface of the membrane filter 210 in parallel, in which a shearing effect takes place on the surface of the membrane filter 210). Thus, setting up the worst case scenario can help mimic CIP filtration deep in the CIP system where it is most likely that fouling has built up, since in the plant configuration the membrane filter 210 builds an active layer between a first and second side of filtration membranes prohibiting larger molecules from passing: especially in some instances enzymes and surfactants.

The first sample is handled with care and sterile gloves and/or instruments so as to preserve a condition of the membrane filter 210 that was taken for the first sample. This is important so as to reduce any possibility of inaccurate readings of enzyme activity, either from unintentionally removing and/or adding enzymes to the first sample. The first sample may then be tested with a GlycoSpot test among other options. A GlycoSpot test instrument for determining enzyme activity may be purchased from GlycoSpot, Østmarken 9, 2860) Soborg, Denmark, optionally through the website https://www.glycospot.dk.

It is understood that multiple samples of membrane filters can be taken from the test vessel 200 in this remove first sample from test vessel step 110a. This simply requires that more of the membrane filter 210 is positioned within the test vessel 200 to begin with.

If the testing results a showing of no enzyme activity on these first samples then production can continue and the following steps can be disregarded.

### Optional Alkalinity Step

Optionally, the membrane can be cleaned with an alkalinity step 106b. The alkalinity step 106b can aid in further deactivating the enzyme by charging portions of the unfolded protein such that it remains unfolded. This step 106b is not required but can aid in deactivation in some contexts. In the alkalinity step 106b, the membrane is contacted with an alkaline composition. The alkaline composition preferably comprises an alkali metal hydroxide, alkali metal carbonate, or mixture thereof. Preferred alkali metal hydroxides include sodium hydroxide, potassium hydroxide, or a mixture thereof. Preferred alkali metal carbonates include sodium carbonate, potassium carbonate, or a mixture thereof. In addition to the alkali metal hydroxide and/or alkali metal carbonate, the alkaline composition can optionally further comprise an alkali metal silicate, a metasilicate, sesquicarbonate, organic sources of alkalinity or mixtures thereof.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

The pH of the alkaline composition used in the optional alkalinity step is preferably from about 9.5 to about 12.0, more preferably from about 9.7 to about 11.8, most preferably from about 10.0 to about 11.5. Preferably the alkalinity step 106b is run through the CIP system for 15 to 45 minutes, and most preferably for about 30 to 40 minutes.

If an alkalinity step is performed, then a final rinse step 107 is performed to remove the alkaline composition. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO (reverse osmosis) water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 30° C. and 70° C., most preferably between 50° C. and 70° C.

### Remove Second Sample From Test Vessel Step

Following the final rinse step 107, the operator can remove the test vessel 200 from the CIP system 600, 610, 620 and take out a second sample from the membrane vessel 210 that was positioned within the container 220. This is referred to as the remove second sample from test vessel step 110b.

The second sample is handled with care and sterile gloves and/or instruments so as to preserve a condition of the membrane filter 210 that was taken for the second sample. This is important so as to reduce any possibility of inaccurate readings of enzyme activity, either from unintentionally removing and/or adding enzyme to the second sample. The second sample may then be tested with a GlycoSpot test among other options. A GlycoSpot test instrument for determining enzyme activity may be purchased from GlycoSpot, Østmarken 9, 2860 Soborg, Denmark, optionally through the website https://www.glycospot.dk.

It is understood that multiple samples can be taken from the test vessel in this remove second sample from test vessel step 110b. This simply requires that more of the membrane filter 210 is positioned within the test vessel 200 to begin with.

If the testing results a showing of no enzyme activity on these second samples then production can continue, otherwise the methods described herein are repeated beginning with the prerinse step 101.

### System Examples

FIG. 4 shows a basic diagram of a CIP system 600. Included in the CIP system 600 are filtration modules 500 and a feed tank 700 (or CIP feed tank) through which fluid can enter the CIP system 600. Given that the feed tank 700 includes an opening for the inserting of fluid (including fluid from the steps 101-107), the test vessel 200 may also be inserted into the feed tank 700. Further, arrows traveling between the feed tank 700 and the filtration module 500 in FIG. 4 represent an at least one pipe for fluids to travel through. A plurality of membrane filters positioned within the filtration module 500 are difficult to access, as the CIP system must be taken apart.

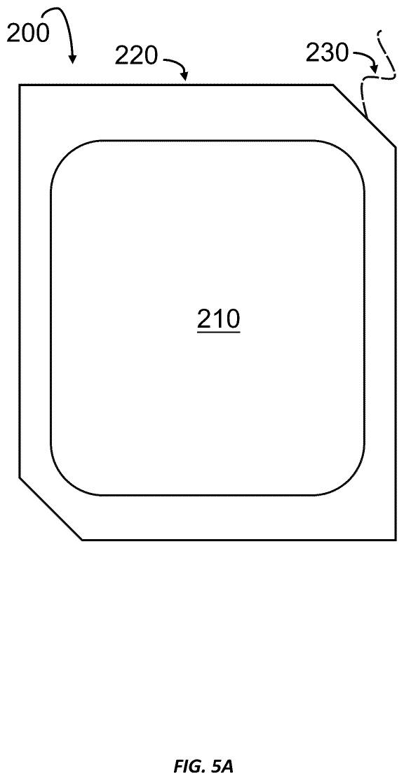

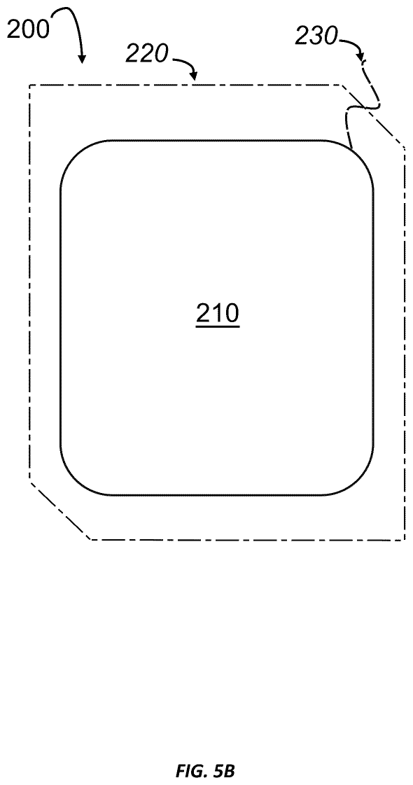

As shown in FIGS. 5A-5B, the test vessel 200 can include a membrane filter 210 positioned within a container 220. It is noted that the membrane filter 210 can include multiple membrane filters 210. The container 220 can be permeable so as to allow fluid to travel therethrough without allowing the membrane filters 210 to escape. The container 220 can further be inert with respect to surfactants, acids, alkalis, etc. that enter the CIP system. Given by example and not of limitation the container 220 can comprise a stainless steel cage.

The test vessel 200 can further include a support member 230, which can be (given by way of example and not of limitation) a chain, a rod, a pulley system, a leverage teeter-toter system, a pneumatic lift, a hydraulic lift, a scissor lift, among other options. If one were for example to install a hydraulic lift it would be similar to that of a hydraulic lift for a vehicle that can be seen in mechanic's shops, wherein the hydraulic lift would be installed within the feed tank 700 to automatically raise and lower the test vessel 200 (which could be fixedly attached to the hydraulic lift with an opening on a top of the test vessel 200 for inserting and removal of the membrane filter 210) from the feed tank 700 at the push of a button. The purpose of the support member 230 is to hold the test vessel 200 underneath a fluid-level line within the feed tank 700 without allowing the test vessel 200 to travel further into the CIP system 600 and to provide a means for lifting the test vessel 200 out of the CIP feed tank 700.

A distinction between FIGS. 5A-5B is that FIG. 5A includes all components for the test vessel 200, whereas FIG. 5B only mandatorily includes the membrane filter 210. In this regard, the test vessel 200 can optionally include the container 220 and the support member 230. For example, the test vessel could simply be multiple membrane filters 210 connected to a chain as the support member 230 by inserting holes through the membrane filters 210. In this regard, the weight of the chain could hold down the membrane filters 210 beneath fluid in the CIP feed tank 700, and the chain could lift the membrane filters 210 out of the CIP feed tank 700 to be tested. Additionally, given by way of example and not of limitation, a set-up could be that the test vessel 200 does not include the support member 230 and comprises only the container 220 and the membrane filter 210 positioned therein. With this assembly, the container 220 could be a cage of sufficient weight and size that it would drift to and sit at a bottom of the CIP feed tank 700 without being able to travel through an at least one pipe exiting the feed tank 700. In this scenario, the container 220 could be fished out so as to gain access to the membrane filter 210. In a further example given by way of example and not of limitation the membrane is placed in a stainless-steel cage and held by a chain mounted to a support structure of the CIP feed tank with the chain connected to the support structure and to the cage by carabiners. The length of the chain can be maintained as the cage is submerged under the liquid level at all times during CIP and rinse.

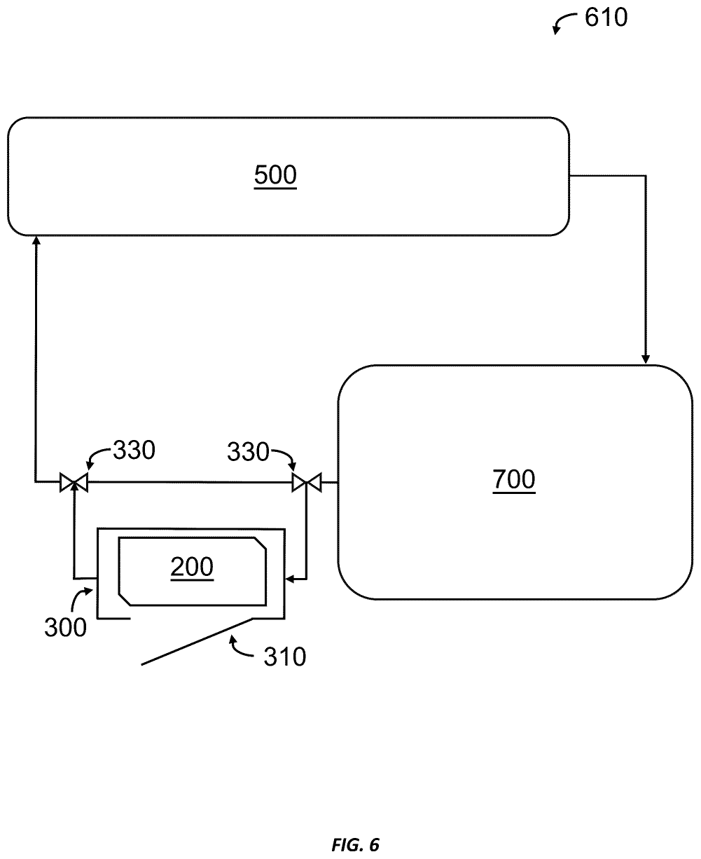

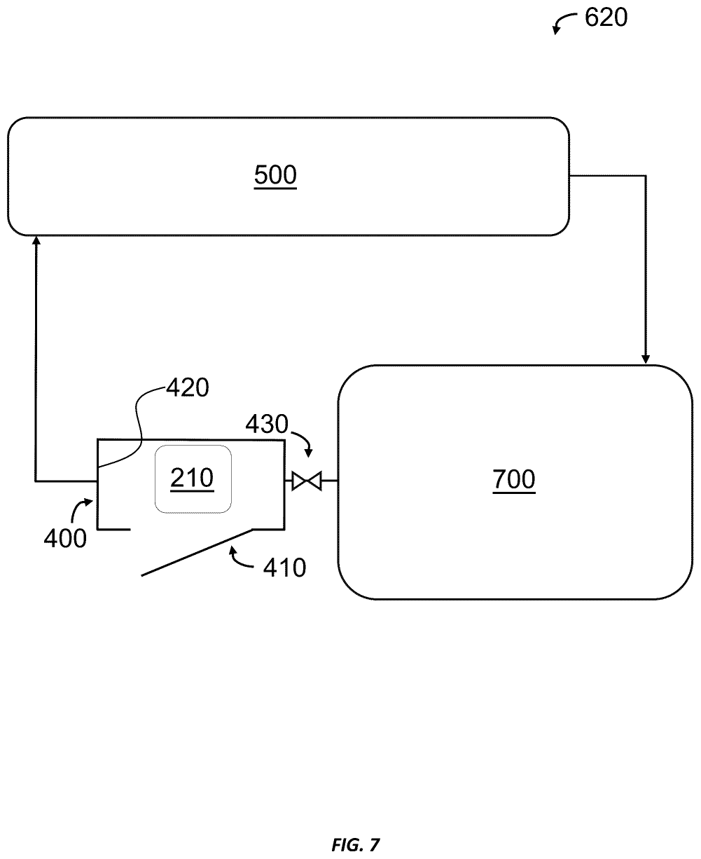

FIGS. 6-7 show alternative embodiments for submersing the membrane filter 210 of the test vessel 200 in a fluid of the CIP system 610, 620. It is noted that although the placement of the test vessel 200 in FIGS. 6-7 could be before the filtration module 500, the test vessel 200 may also be placed in a configuration downstream from the filtration module 500 instead of upstream of the filtration module 500.

In FIG. 6, the test vessel 200 is designed to work in-line on-demand with the at least one pipe downstream of the CIP feed tank 700. In this configuration, the test vessel 200 is placed into a larger container 300 which has pipes connecting the larger container 300 to the at least one pipe exiting the CIP feed tank 700. The larger container 300 includes an opening 310 through which the test vessel 200 may be inserted and removed. Without intervention from an operator, fluid in the CIP system will not travel through the larger container 300. An operator must trigger the valves 330 so as to direct flow from the at least one pipe to the larger container 300 and back to the at least one pipe. This process of triggering the valves 330 can be automated upon validation that the test vessel 200 has entered the larger container 300 and that the opening 310 has been sealed shut. Note that although the test vessel 200 is shown to be contained within the larger container 300, the larger container 300 can be constructed such that only insertion of the membrane filter 210 is needed, and this is explained in further detail with FIG. 7.

In FIG. 7, a larger container 400 has been directly inserted in-line with the at least one pipe exiting the CIP feed tank 700. The larger container 400 has an opening 410 that is sealable and the membrane filter 210 has been inserted into the larger container 400. In this configuration, the larger container 400 includes a permeable surface 420 such as a grate or filter to keep the membrane filter 210 from traveling downstream the at least one pipe. As such, the larger container 400 when sealed will retain all fluids (i.e., won't leak) for fluids passing through the larger container 400 to continue further down the at least one pipe, and will not allow objects such as the membrane filter 210 to travel further down the at least one pipe. In this configuration it is desirable to include a valve 430 so as to facilitate opening the larger container 400 without requiring the CIP feed tank 700 to be emptied. The valve 430 is optional and configurations of the larger container 400 are possible such that opening the larger container 400 would not cause fluid to leak from the larger container 400 when fluid remains in the CIP feed tank 700. Given by example and not of limitation, the opening 410 could be on a top of the larger container 400 and the opening 410 could be configured such that it is elevated above a fluid level of the CIP feed tank 700 so as to reduce a possibility of fluid traveling through the at least one pipe from spilling out the larger container 400.

As such, it is understood that various combinations and configurations are possible, while maintaining an ability to submerge a test vessel 200 (including the membrane filter 210) in fluid that travels through a CIP system so as to gain an understanding of enzyme activity from the plurality of membrane filters positioned in the filtration module 500 which are more difficult to access than the test vessel 200.

### PREFERRED EMBODIMENTS

The inventions are defined in the claims. However, below is a non-exhaustive list of non-limiting embodiments in numbered format. Any one or more of the features of these embodiments may be combined with any one or more features of another example, embodiment, or aspect described herein. Accordingly, the following numbered embodiments also form part of the present disclosure:

Embodiment 1. A system for deactivating enzymes, comprising:
a cleaning-in-place system comprising:
   a feed tank with an opening, the feed tank operatively connected to an at least one pipe; and
   an at least one filtration module positioned downstream the at least one pipe, the at least one filtration module containing a plurality of membrane filters therein:
a container containing a membrane filter positioned within the container, wherein the membrane filter is comprised of a same membrane type as the plurality of membrane filters that are within the at least one filtration module; and
an inactivator composition, wherein the feed tank is filled with the inactivator composition,
   wherein the inactivator composition is capable of deactivating enzymes including any of lipase, protease, or amylase, wherein the inactivator composition reaches the plurality of membrane filters because the feed tank is operatively connected to the at least one pipe with the at least one filtration module positioned downstream the at least one pipe:
wherein the membrane filter positioned within the container is submerged in the inactivator composition.

Embodiment 2. The system of embodiment 1, wherein the container is positioned in the feed tank.

Embodiment 3. The system of embodiment 1, wherein the container is positioned in-line with the at least one pipe, downstream from the feed tank and upstream from the filtration module.

Embodiment 4. The system of embodiment 3, wherein the container includes a closable opening for insertion and removal of the membrane filter.

Embodiment 5. The system of embodiment 3 or 4, wherein the container is placed in-line with the at least one pipe via a first valve on the at least one pipe positioned upstream of the container, and a second valve on the at least one pipe positioned downstream of the container to divert flow form the at least one pipe to the container and back to the at least one pipe.

Embodiment 6. The system of embodiment 3 or 4, wherein the container includes at least one permeable surface to allow fluids to travel therethrough without allowing the membrane filter to travel therethrough.

Embodiment 7. The system of any one of embodiments 1-6, wherein the container is permeable.

Embodiment 8. The system of any one of embodiments 1-7, wherein the container includes a closable opening for insertion and removal of the membrane filter.

Embodiment 9. The system of any one of embodiments 1-8, wherein the container is inert to the inactivator composition.

Embodiment 10. The system of any one of embodiments 1-9, wherein the inactivator composition includes a pH below 2.0, and an entirety of the cleaning-in-place system is open to receive the inactivator composition.

Embodiment 11. A method for verifying correct dosing of inactivator composition and/or correct inactivation conditions such as pH, temperature, or time, within a cleaning-in-place system (CIP system), comprising:
placing a membrane filter in a test vessel:
placing the test vessel in a feed tank of the CIP system:
inserting an enzyme composition into the feed tank:
circulating the enzyme composition throughout the CIP system:
inserting an inactivator composition into the feed tank capable of deactivating enzymes within the enzyme composition previously inserted into the CIP system:
circulating the inactivator composition throughout the CIP system:
removing the test vessel from the feed tank:
removing the membrane filter from the test vessel; and testing the membrane filter for enzyme activity:
wherein the CIP system includes a plurality of membrane filters positioned downstream from the feed tank within the CIP system that interact with both the enzyme composition and the inactivator composition when the enzyme composition and the inactivator composition are circulated throughout the CIP system, wherein the plurality of membrane filters are not accessible through from the feed tank, wherein the membrane filter that is tested for enzyme activity is tested instead of the plurality of membrane filters positioned downstream from the feed tank.

Embodiment 12. The method of embodiment 11, further comprising inserting a surfactant, and further comprising testing the membrane filter for residual surfactant in addition to testing for enzyme activity.

Embodiment 13. The method of embodiment 11 or 12, further comprising each of inserting an intermediate rinse into the feed tank, circulating the intermediate rinse throughout the CIP system, and draining the intermediate rinse, all after circulating the enzyme composition throughout the CIP system.

Embodiment 14. The method of embodiment 13, further comprising inserting an additional membrane filter in the test vessel during inserting the membrane filter in the test vessel, and further comprising reinserting the test vessel, with the additional membrane filter still positioned therein, into the feed tank after testing the membrane filter for enzyme activity.

Embodiment 15. The method of any one of embodiments 11-14, wherein a pH of the inactivator composition is below 2.0, the inactivator composition is circulated for at least 20 minutes, and an entirety of the cleaning-in-place-system is open to receive the inactivator composition during circulation of the inactivator composition.

Embodiment 16. A method for deactivating enzymes on a plurality of membrane filters positioned in filtration modules within a cleaning-in-place system (CIP system), comprising:
inserting a membrane filter of a same type as the plurality of membrane filters into a container that is separate from the CIP system, wherein the container is closable and permeable:
inserting the container into a feed tank of the CIP system (CIP feed tank), such that the container will remain in the CIP feed tank submerged in fluid while fluids in the CIP feed tank will exit the CIP feed tank to travel throughout the CIP system:
inserting an enzyme composition into the CIP feed tank for traveling through the CIP system; inserting an inactivator composition capable of deactivating the enzyme composition into the CIP feed tank for traveling through the CIP system after the insertion of the enzyme composition, such that the inactivator composition will reach the plurality of membrane filters positioned in filtration modules:

removing the container from the CIP feed tank after insertion of the inactivator composition;
removing the membrane filter from the container; and
testing the membrane filter for enzyme activity instead of the plurality of membrane filters positioned in filtration modules for assessing deactivation of the enzyme composition on the plurality of membrane filters positioned in filtration modules within the CIP system.

Embodiment 17. The method of embodiment 16, wherein the inactivator composition travels through the CIP system for at least thirty minutes.

Embodiment 18. The method of any one of embodiments 16-17, wherein the container is inert to both the enzyme composition and the inactivator composition.

Embodiment 19. The method of any one of embodiments 16-18, wherein the temperature of fluids in the CIP system during insertion of the enzyme composition and insertion of the inactivator composition is at least forty-eight-degrees Celsius.

Embodiment 20. The method of any one of embodiments 16-19, further comprising inserting a first intermediate rinse into the CIP feed tank between the insertion of the enzyme composition and the insertion of the inactivator composition.

Embodiment 21. The method of embodiment 20, further comprising inserting a second intermediate rinse into the CIP feed tank after insertion of the inactivator composition and before removal of the container from the CIP feed tank.

Embodiment 22. The method of any one of embodiments 16-21, wherein a pH of fluids in the CIP system are between 9.5-10.0 during inserting of the enzyme composition.

Embodiment 23. A method for cleaning-in-place a plurality of membrane filters positioned in filtration modules within a cleaning-in-place system (CIP system), comprising:
inserting pre-rinse in a feed tank of the CIP system (CIP feed tank) for traveling through the CIP system:
inserting a membrane filter of a same type as the plurality of membrane filters into a container that is separate from the CIP system, wherein the container is closable and permeable:
inserting the container into the CIP feed tank, such that the container will remain in the CIP feed tank while the pre-rinse and other fluids freely travel through the CIP system:
inserting a chelator into the CIP feed tank for traveling through the CIP system for reducing water hardness until water in the CIP system is about zero grains per gallon with respect to calcium ions:
reaching a temperature of at least 50-degrees Celsius for fluid in the CIP system:
inserting lipase into the CIP feed tank for traveling through the CIP system after fluid in the CIP system has reached 50-degrees Celsius:
inserting protease and a surfactant into the CIP feed tank for traveling through the CIP system for twenty to thirty minutes after the lipase has been inserted and run through the CIP system for forty-five to sixty minutes:
inserting a first intermediate rinse into the CIP feed tank for traveling through the CIP system to flush out the lipase, protease, and surfactant from the CIP system:
inserting an acidic composition of pH of less than 2.0 capable of deactivating lipase into the CIP feed tank for traveling through the CIP system after the first intermediate rinse:
inserting a second intermediate rinse into the CIP feed tank for traveling through the CIP system to rinse out the acidic composition until fluid in the CIP system reaches a pH of between 6.0 to 7.0;
removing the container from the CIP feed tank:
removing a first sample from the membrane filter from the container; and
testing the first sample for lipase activity.

Embodiment 24. The method of embodiment 23, further comprising inserting the container back into the CIP feed tank with the membrane filter therein, and further inserting an alkaline composition into the CIP feed tank of pH greater than 11.0 for traveling through the CIP system for about thirty minutes, and after the about thirty minutes inserting a final rinse into the CIP feed tank for traveling through the CIP system to rinse all fluids from the CIP system.

Embodiment 25. The method of embodiment 23 or 24, wherein the temperature of fluids in the CIP system are above forty-eight-degrees Celsius during inserting the acidic composition and during inserting the alkaline composition of the method of embodiment 24.

Embodiment 26. The method of any one of embodiments 23-25, further comprising removing the container from the CIP feed tank after the final rinse, removing a second sample from the membrane filter from the container, and testing the second sample for lipase activity, wherein if the second sample contains lipase activity then the method of embodiment 25 (including all steps of embodiments it depends from) is repeated.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments, in addition to those shown and described herein, will be apparent to those skilled in the art from the foregoing description. Such modifications are also intended to fall within the scope of the appended claims.

### Example 1

Objective: Analytical testing that within CIP SOP lipase can be inactivated and have no negative influence on final dairy product. Further, proof by measurement that the inactivation chemistry was dosed correctly and that inactivation conditions were properly conducted such as temperature, time, and pH sufficient to inactivate the given enzymes (protease can be inactivated e.g. with pH<2, 50° C., for 20 min, so if the protease enzymes are inactive then these conditions were satisfied).

Challenge: Develop lab equipment necessary to measure Lipase activity in complicated dairy products. Every Membrane process is different, so it is difficult to compare between different membrane plants. Further, microbes also create lipase and free fatty acids with an off-taste to dairy products after introduction of lipase into the CIP system. Further, it is difficult to test low parts per billion (ppb) lipase activity in CIP systems with difficult-to-reach membrane samples.

Set up: Lipase activity determination for food products were performed. Sensory panel studies were executed to access the right acceptance limit in long term studies. Membrane filters removed from test vessels and directly tested for lipase activity in dairy products after lipase CIP. Furthermore, full scale trials of various dairy plants took samples of product after lipase CIP and compared vs. non-lipase samples. Ecolab Lipase Inactivation test kit by GlycoSpot used to test inactivation of lipase after the acidic step on membrane samples. The samples were removed from test vessels rather than membranes from within the filtration modules of CIP systems.

Outcome: Validation with dairy product samples after the lipase deep clean did not show any off taste and results of lipase activity below acceptance level in dairy products. No effect to dairy ingredients within acceptance limit. Further, with the Inactivation test kit it is possibly to verify that the inactivation chemistry was used correctly. No lipolytic activity for 6 lipase CIP test at 3 different dairy sites.

The disclosures being thus described, it will be obvious that the same may be varied in many ways. Such variations are not to be regarded as a departure from the spirit and scope of the disclosures and all such modifications are intended to be included within the scope of the following claims. The above specification provides a description of the manufacture and use of the disclosed compositions and methods. Since many embodiments can be made without departing from the spirit and scope of the disclosure, the invention resides in the claims.

What is claimed is:

1. A system for deactivating enzymes, comprising:
a cleaning-in-place system comprising:
a feed tank with an opening, the feed tank operatively connected to an at least one pipe; and
an at least one membrane filtration module positioned downstream the at least one pipe, the at least one filtration module containing a plurality of membrane filters therein;
a container containing a membrane filter positioned within the container, wherein the membrane filter is comprised of a same membrane type as the plurality of membrane filters that are within the at least one membrane filtration module; and
an inactivator composition, wherein the feed tank is filled with the inactivator composition, wherein the inactivator composition is capable of deactivating enzymes including any of lipase, protease, or amylase, wherein the inactivator composition reaches the plurality of membrane filters because the feed tank is operatively connected to the at least one pipe with the at least one membrane filtration module positioned downstream the at least one pipe;
wherein the membrane filter positioned within the container is submerged in the inactivator composition.

2. The system of claim 1, wherein the container is positioned in the feed tank.

3. The system of claim 2, wherein the container is permeable.

4. The system of claim 3, wherein the container includes a closable opening for insertion and removal of the membrane filter.

5. The system of claim 4, wherein the container is inert to the inactivator composition.

6. The system of claim 1, wherein the container is positioned in-line with the at least one pipe, downstream from the feed tank and upstream from the membrane filtration module.

7. The system of claim 6, wherein the container includes a closable opening for insertion and removal of the membrane filter.

8. The system of claim 7, wherein the container is placed in-line with the at least one pipe via a first valve on the at least one pipe positioned upstream of the container, and a second valve on the at least one pipe positioned downstream of the container to divert flow form the at least one pipe to the container and back to the at least one pipe.

9. The system of claim 7, wherein the container includes an at least one permeable surface to allow fluids to travel therethrough without allowing the membrane filter to travel therethrough.

10. A method for verifying correct dosing of inactivator composition and/or correct inactivation conditions such as pH, temperature, or time, within a cleaning-in-place system (CIP system), comprising:
placing a membrane filter in a test vessel;
placing the test vessel in a feed tank of the CIP system;
inserting an enzyme composition into the feed tank;
circulating the enzyme composition throughout the CIP system;
inserting an inactivator composition into the feed tank capable of deactivating enzymes within the enzyme composition previously inserted into the CIP system;
circulating the inactivator composition throughout the CIP system;
removing the test vessel from the feed tank;
removing the membrane filter from the test vessel; and
testing the membrane filter for enzyme activity;
wherein the CIP system includes a plurality of membrane filters positioned downstream from the feed tank within the CIP system that interact with both the enzyme composition and the inactivator composition when the enzyme composition and the inactivator composition are circulated throughout the CIP system, wherein the plurality of membrane filters are not accessible through from the feed tank, wherein the membrane filter that is tested for enzyme activity is tested instead of the plurality of membrane filters positioned downstream from the feed tank.

11. The method of claim 10, further comprising inserting a surfactant, and further comprising testing the membrane filter for residual surfactant in addition to testing for enzyme activity.

12. The method of claim 10, further comprising each of inserting an intermediate rinse into the feed tank, circulating the intermediate rinse throughout the CIP system, and draining the intermediate rinse, all after circulating the enzyme composition throughout the CIP system.

13. The method of claim 12, further comprising inserting an additional membrane filter in the test vessel during inserting the membrane filter in the test vessel, and further comprising reinserting the test vessel, with the additional membrane filter still positioned therein, into the feed tank after testing the membrane filter for enzyme activity.

14. A method for deactivating enzymes on a plurality of membrane filters positioned in filtration modules within a cleaning-in-place system (CIP system), comprising:
inserting a membrane filter of a same type as the plurality of membrane filters into a container that is separate from the CIP system, wherein the container is closable and permeable;
inserting the container into a feed tank of the CIP system (CIP feed tank), such that the container will remain in the CIP feed tank submerged in fluid while fluids in the CIP feed tank will exit the CIP feed tank to travel throughout the CIP system;
inserting an enzyme composition into the CIP feed tank for traveling through the CIP system;
inserting an inactivator composition capable of deactivating the enzyme composition into the CIP feed tank for traveling through the CIP system after the insertion of the enzyme composition, such that the inactivator composition will reach the plurality of membrane filters positioned in filtration modules;
removing the container from the CIP feed tank after insertion of the inactivator composition;
removing the membrane filter from the container; and
testing the membrane filter for enzyme activity instead of the plurality of membrane filters positioned in filtration modules for assessing deactivation of the enzyme composition on the plurality of membrane filters positioned in filtration modules within the CIP system.

15. The method of claim 14, wherein the inactivator composition travels through the CIP system for at least thirty minutes.

16. The method of claim 15, wherein the container is inert to both the enzyme composition and the inactivator composition.

17. The method of claim 16, wherein the temperature of fluids in the CIP system during insertion of the enzyme composition and insertion of the inactivator composition is at least forty-eight-degrees Celsius.

18. The method of claim 17, further comprising inserting a first intermediate rinse into the CIP feed tank between the insertion of the enzyme composition and the insertion of the inactivator composition.

19. The method of claim 18, further comprising inserting a second intermediate rinse into the CIP feed tank after insertion of the inactivator composition and before removal of the container from the CIP feed tank.

20. The method of claim 19, wherein a pH of fluids in the CIP system are between 9.5-10.0 during inserting of the enzyme composition.
